(19) United States
(12) Patent Application Publication
(10) Pub. No.: US 2004/0024714 A1
(43) Pub. Date: Feb. 5, 2004

(54) Electronic safe deposit box

(76) Inventors: Thomas E. Wells, Coral Gables, FL (US); Eric K. Yee, Fremont, CA (US)

Correspondence Address: GARDNER CARTON & DOUGLAS LLP, 191 N. WACKER DRIVE, SUITE 3700, CHICAGO, IL, 60606, US

(21) Appl. No.: 10/168,944

(22) PCT Filed: Dec. 29, 2000
(86) PCT No.: PCT/US00/35552

(51) Int. Cl. G06F 17/60

(52) U.S. Cl. 705/78

(57) ABSTRACT

An electronic safe deposit box system (the “ESDB System”) is disclosed. The ESDB System identifies each of the users and each of the electronic files representing written information, data or documents with an alphanumeric code. The ESDB System electronically stores written information, data and documents sent to the ESDB System. Electronic maintained in the ESDB System may be accessed using an open network or group of servers such as the Internet or a closed network or group of servers such as an Intranet or LAN. Each user has a user identification, password and personal identification number (“PIN”). The ESDB System allows the user to designate third parties to access a user-controlled electronic safe deposit box. The third party may only view or print specific electronic files to which the user has previously granted the third party access. In addition, the ESDB System tracks the activity of third parties within the user's electronic safe deposit box, and automatically notifies, by email, the owner of the box of such activities.

### COPYRIGHT NOTICE

A portion of the disclosure of this patent document contains material that is subject to copyright protection. The protection owner has no objection to the facsimile reproduction by anyone of the patent document, or of the patent disclosure as it appears in the Patent and Trademark Office patent files or records, but otherwise reserves all copyrights whatsoever.

### I. FIELD OF THE INVENTION

The invention relates to the archival, retrieval and use of electronically-stored information, data, documents and other forms, and more particularly to an electronic, guided system and method for. (a) the archival, retrieval and use of electronically-stored information, data and documents such as bank records, account statements, insurance policies, tax returns, legal agreements and other writings either on an open network or group of servers such as the Internet, a closed network or group of servers such as an Intranet, or a local area network (“LAN”); and (b) recording and reporting the access to and the activities performed with such electronically-stored information, data and documents.

### II. BACKGROUND OF THE INVENTION

In order to share written information, data or documents among people, such information, data or documents can be mailed, sent by overnight delivery or other private courier/hand delivery service, faxed or emailed to the intended recipient. All of these systems have inherent advantages and problems. Mailing or sending documents by overnight delivery or other private courier/hand delivery service is costly, labor-intensive and slow. Faxing a document is also labor intensive, is dependent upon open access through telephone lines, and requires both the sender and the recipient to have access to fax machines. Sending a document as an attachment to email spreads email viruses, may not be opened with certain word processing programs, requires the sender to know the recipient's current email address, requires the sender and the recipient to maintain an email address, may suffer from lack of security if transmitted over the Internet, and may require that the recipient access the email and attachment only on the computer that received such email.

In a preferred embodiment, these problems are solved by an electronic safe deposit box system (the “ESDB System”) of the present invention. The ESDB System idees each of the users and each of the electronic files representing written information, data or documents with an alphanumeric code. The ESDB System electronically stores written information, data and documents sent to the ESDB System: (a) by mail, or by overnight delivery or other private courier/hand delivery in hard copy, which hard copy is electronically scanned and converted it into an electronic file; or (b) by fax which is converted to an electronic file (collectively, “Offline Documents”). A person of ordinary skill in the art would appreciate that information may also be transmitted to the ESDB System in other ways, such as via e-mail or modem.

The ESDB System may be integrated with the Electronic Form Generator (described in the Provisional Application entitled “Electronic Legal Form Generator,” S/N No. 60/162,286, and filed by the applicant and inventors on Oct. 28, 1999 with the United States Patent and Trademark Office; the foregoing patent is hereby incorporated by reference in its entirety) to present a “virtual” document to the user in which an electronic file containing certain answers to a specified legal template is combined with a separate electronic file containing the specified legal template (“Virtual Documents”). Both the Offline Documents and the Virtual Documents maintained in the ESDB System may be accessed using an open network or group of servers such as the Internet or a closed network or group of servers such as an Intranet or LAN. Each user has a user identification, password and personal identification number (“PIN”). Therefore, if the user correctly inserts the user's identification, password and PIN, the electronic files contained in the ESDB System can be accessed immediately by the user from any computer. This ESDB System eliminates the inherent problems m sending written information, data or documents by mail overnight delivery or other private courier/hand delivery service, fax or email

This ESDB System allows the user to designate third parties to access a user-controlled electronic safe deposit box. The third party may only view or print specific Offline Documents or Virtual Documents to which the user has previously granted the third party access. The ESDB System is a significant improvement upon the Internet Hard-Drive Systems because third parties are unable to modify, add, delete or email the documents in the user's electronic safe deposit box. In addition, the ESDB System tracks the activity of third parties within the user's electronic safe deposit box, and automatically notifies, by email the owner of the box: (a) when a third party accesses his box; (b) when the third party is no longer accessing his box; and (c) the activities performed by the third party during such access to the box.

### III. BRIEF DESCRIPTION OF THE DRAWINGS

References are made to the following description taken in connection with the accompanying drawings, in which:

FIG. 1 is a screen shot of an exemplary sign-in HTML page;

FIG. 2 is a screen shot of an initial dynamic HTML page after the system has authorized the user to enter the system and access its functionality;

FIG. 3 is a screen view of a dynamic HTML page occurring after a user has selected the “StoreDocsOnline” option from the menu shown in FIG. 2;

FIG. 4 is an exemplary screen view of a dynamic HTML page showing the folders of electronic files available to the user in his own electronic safe deposit box after he has submitted his PIN in FIG. 3 and this PIN corresponds to the Member's Log-In and the Member Password;

FIG. 5 is an exemplary screen view of a dynamic HTML page showing the electronic ties included in the user's healthcare document folder and is presented to the user after the user clicks the hypertext link healthcare document folder,

FIGS. 6 and 7 show the document provided to the user if he clicks the Living Will hypertext link file, checks the “View Document” box and presses the “Submit/Send” key,

FIG. 8 is an exemplary screen view of a dynamic HTML page presented to someone who has been granted access by the user to his electronic safe deposit box;

FIG. 9 is an exemplary screen view of a dynamic HTML page presented to a person other than the owner of the electronic safe deposit box after such person clicks the healthcare document folder hypertext link;

FIG. 10 is an exemplary screen presented to the user within the user's electronic safe deposit box if the user clicks the “add/delete/modify third party access” hypertext link pursuant to the Box Management Tools shown in FIG. 4;

FIG. 11 is an exemplary screen view of a dynamic H page presented to the user after the user has clicked the “delete/modify third party access” hypertext link in order to modify the access of someone that currently has access to the user's electronic safe deposit box; and

FIG. 12 is an exemplary screen view of a dynamic HTML page presented to the user after the user has clicked the “review prior box activity” hypertext link

### IV. DETAILED DESCRIPTION OF PREFERRED EMBODIMENTS

The present invention relates to a system and method for: (a) the archival retrieval and use of electronically-stored information, data and documents such as bank records, account statements, insurance policies, tax returns, legal agreements and other forms; and (b) recording and reporting the access to and the activities performed with such electronically-stored information, data and documents. When a user logs on to a network or collection of servers, such as the Internet, an Intranet or a LAN, the user may access a web site containing a menu-driven series of options. These options direct the user to add his or her Member Log-In (also referred to as the user's identification), Member Password and PIN. When all these items correlate to the same user, that user is granted access either to his or her own electronic safe deposit box or to the electronic safe deposit box of another party. If the user fails to submit all of this information prior to accessing the ESDB System, a message will prompt the user to submit this information before access is granted

The user may only access the electronic safe deposit box of another party if that other party has previously granted access to the user to access the other party's electronic safe deposit box. The other party grants the user access to the other party's electronic safe deposit box through the ESDB System by referring to the user's identification.

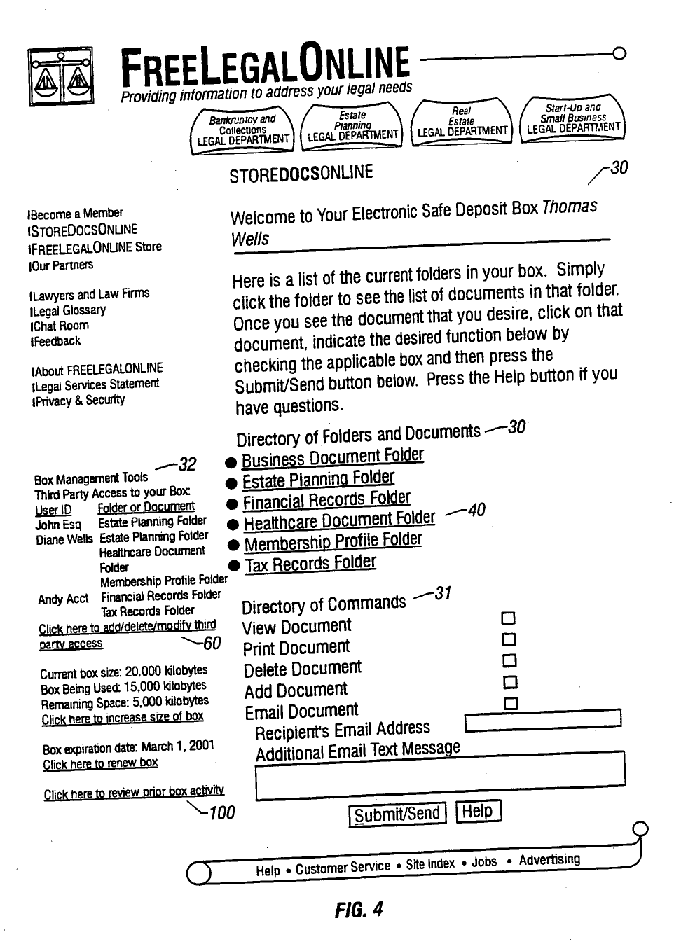

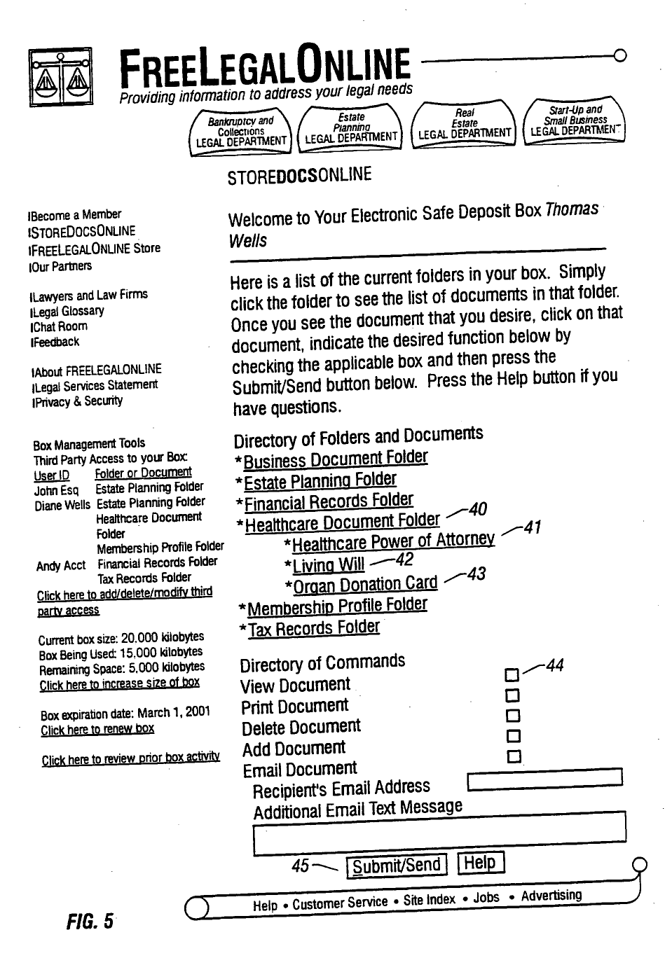

Referring now to FIG. 4, when the user is granted access to his own electronic safe deposit box, the ESDB System greets the user and provides the user with a list of folders used to sort the electronic files of written information, data and documents contained in the ESDB System. The user is also presented with options to view document, print document, delete document, add document or email document. If the user desires to access a particular document, he clicks the hypertext link folder containing the electronic file of the desired document, and the ESDB System then presents a “drill-down” menu of the electronic files contained in the particular folder, as shown in FIG. 5. The user can then direct the ESDB System to perform one of the listed functions by clicking on the desired hypertext link electronic file, checking the applicable function and pressing Submit/Send key. If the user desires to email the file, he must also add the email address and may provide an additional text message that will be added to the email. After the correct steps are taken and the user presses the Submit/Send key, the ESDB System sends the email message with the electronic file as an attachment.

Both Offline Documents and Virtual Documents can be added to the ESDB System. To add an Offline Document to the ESDB System, the written information, data and documents are sent to the ESDB System either (a) by mail, or by overnight delivery or other private courier/hand delivery in hard copy that is scanned and converted into an electronic file; (b) by fax that is converted to an electronic file; or (c) by any other communication means, such as email or modem. The ESDB System is integrated with the Electronic Form Generator and can present Virtual Documents to the user by combining an electronic file containing certain answers to a specified legal template with a separate electronic file containing the specified legal template. Virtual Documents are added to the ESDB System by a user through a process described in the Electronic Form Generator.

Each electronic file representing an Offline Document and each electronic file of answers relating to a Virtual Document contains header information setting forth, among other things: (a) the assigned alphanumeric code for such file; (b) the alphanumeric code of the owner of such file (i.e., the user who has submitted the file into the system); (c) the date on which such electronic file was added into the ESDB System; (d) a alphanumeric code indicating the activity taken with respect to that document (e.g., print, view, email, etc. . . . ), and the date on which such activity was taken; (e) the particular pre-designated folder(s) in which the user desires to store the electronic file; and (f) third parties who have been given access by the owner to view and print such Offline Document or Virtual Document

If the user desires to delete an electronic file from his electronic safe deposit box, the user clicks the hypertext link of the particular file, checks the “delete document” box and presses the Submit/Send key. The ESDB System then notifies the system administrator of the deleted file and electronically sends a copy of the Offline Document or the Virtual Document to the user's designated email address.

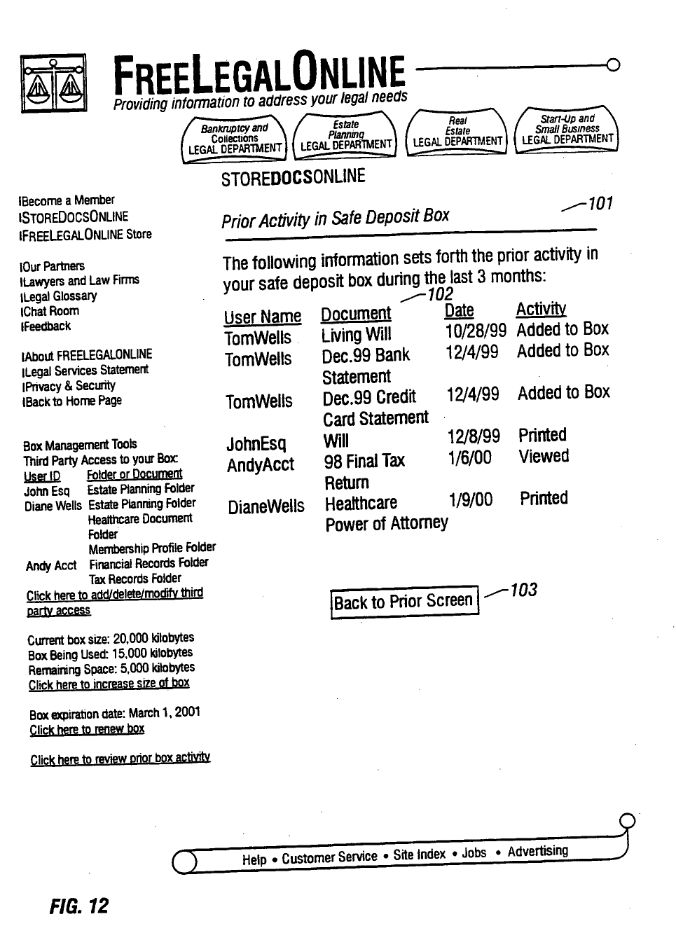

The ESDB System integrates a sophisticated tracking and communications process that electronically notifies the user by email that a third party is accessing the user's electronic safe deposit box and the identification of the third party. When the third party leaves the user's electronic safe deposit box, another email is automatically sent to the user reporting which documents the third party viewed and which documents the third party printed. The ESDB System also tracks the activity conducted with the electronic files contained in the user's box and the user can access a record of such activity through the Box Management Tools, as shown in FIG. 12.

In order for a third party to obtain access to a user's box, the third party must first register with the ESDB System and obtain a unique user's identification, password and PIN. The user may grant a pre-registered third party access to the user's box by designating such third party by the third party's ESDB System identification. The user can grant access either to a particular electronic file(s), a particular folder(s) or all of the electronic files or folders in the user's box.

The user has access to certain Box Management Tools which allow the user to add/delete/modify a third party's access to the user's electronic safe deposit box, increase the size of the electronic files that may be stored in the box, renew the license to the box and review the prior activity taken within the box. The Box Management Tools indicate those third parties with designated access to the user's box, the folders or electronic files to which the third parties have access, the aggregate size of the electronic files stored within the user's box, the remaining size available for additional storage and the expiration date of the user's box.

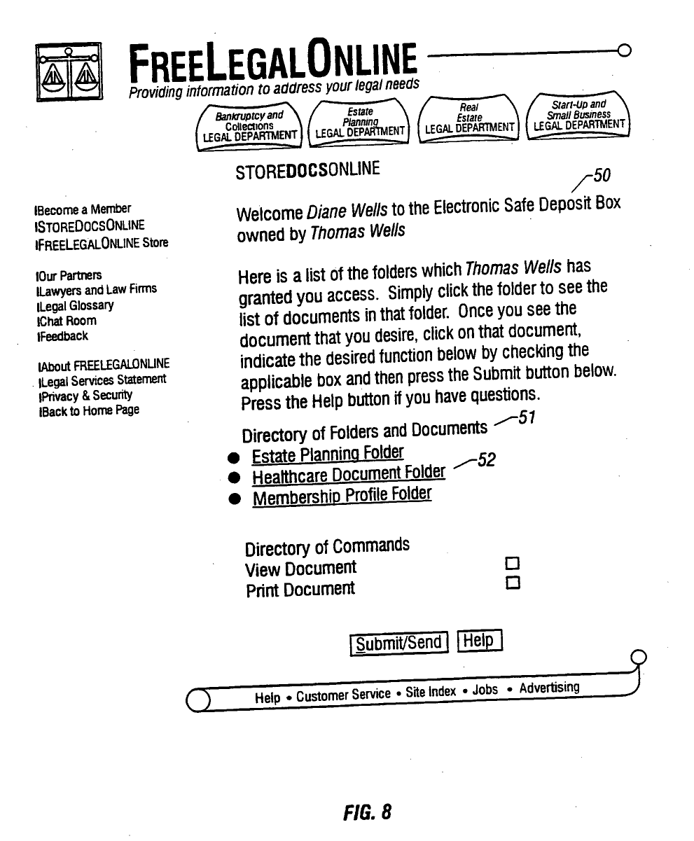

As shown in FIG. 8, the functions available to a third party accessing a user's box are normally limited to printing a document or viewing a document This prevents the third party from modifying or deleting the document without the user's authorization. In addition, the third party normally does not have access to the Box Management Tools provided to the user.

In a preferred embodiment, all communications to and from the ESDB System are encrypted using SSL technology. The Virtual Documents are presented to the user or third party in dynamic HTML with the answer file prepared in Java and Java Script and inserted into the dynamic HTML form template. The Offline Documents are converted from a word-processing format or other language into a gif, jpeg, rtf or other standardized file (such as those viewable by Adobe's Acrobat Reader®) and presented to the user or third party in such file format

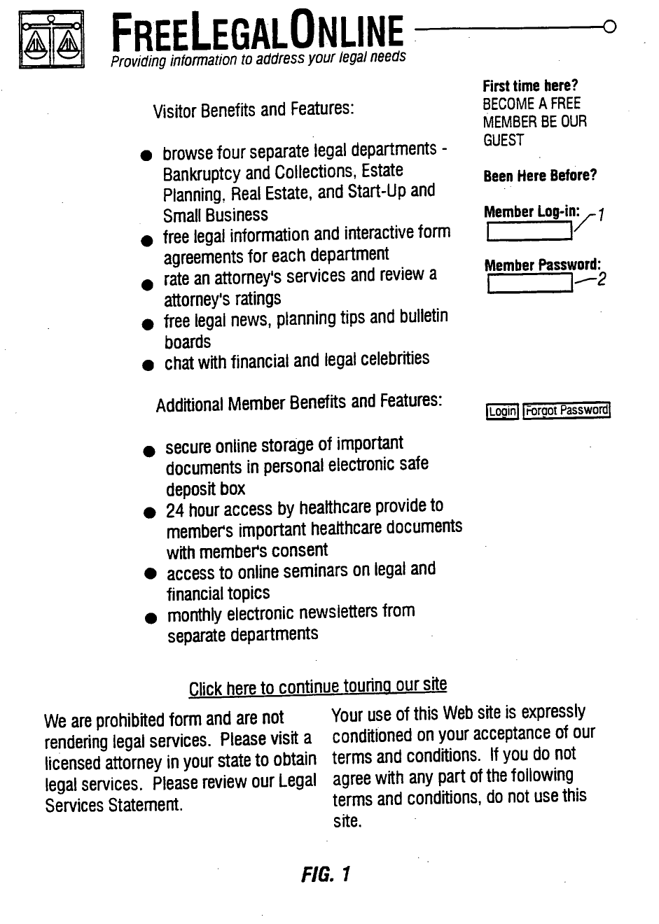

Referring now to FIG. 1, when a user accesses the Internet web site associated with the present invention, the user may enter input information in the member log-m box 1 and the member password box 2, reflecting the user's login name/identification and password, respectively. Alternatively, this input information may not be required by the web site. However, the user will have to provide this information prior to accessing the ESDB System.

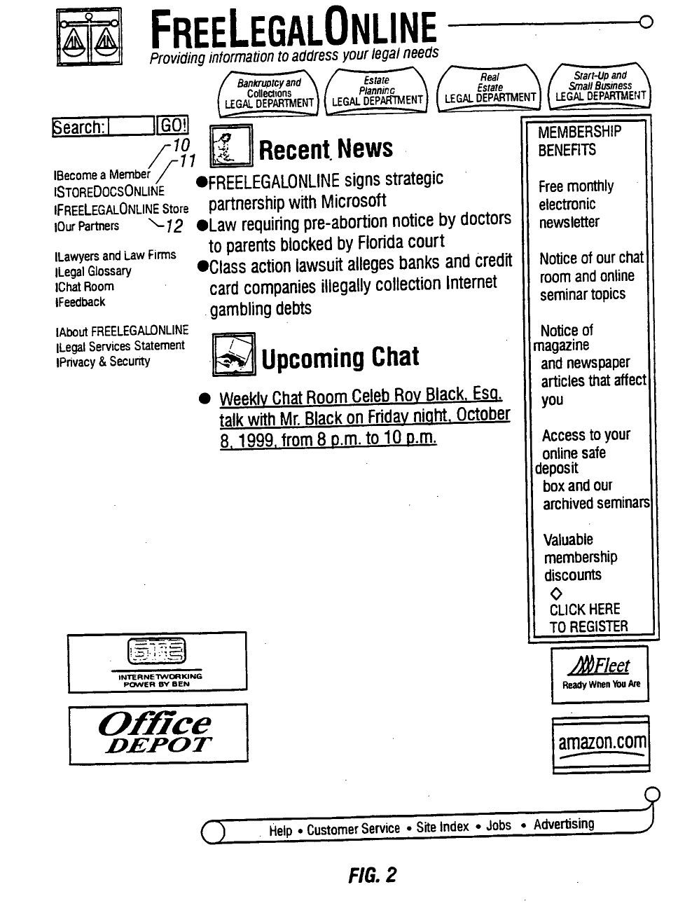

After obtaining authorization to further access the contents of the web site, the user may proceed to a menu of options such as that set forth in FIG. 2. The menu may appear on the screen, such as with respect to menu listings 10, 11 and 12.

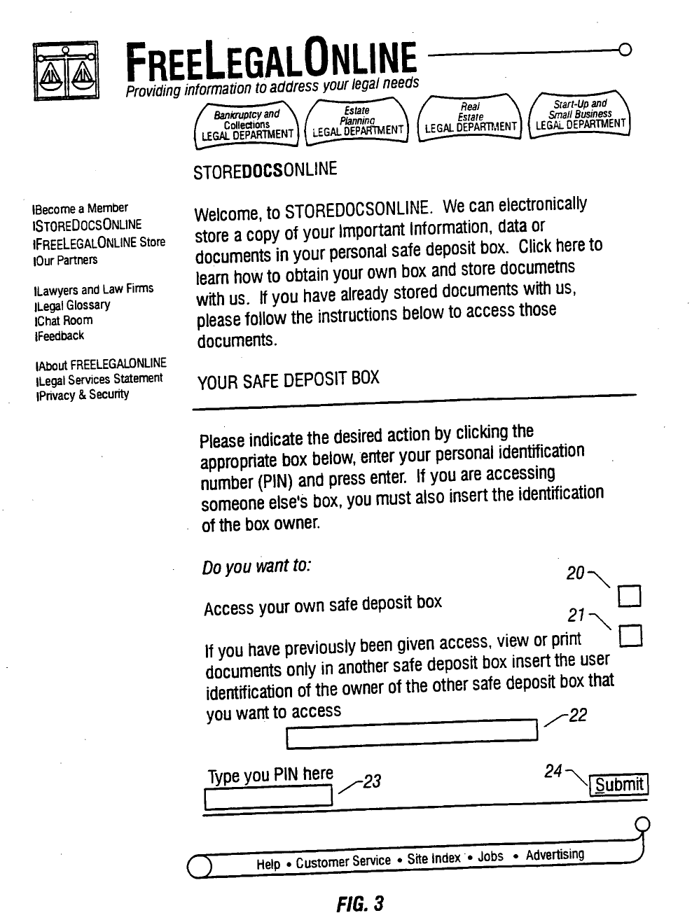

Assuming the user chooses to access the STOREDOCSONLINE area of the web site, the user will be presented with a dynamic HTML page as shown in FIG. 3. The user is requested to indicate to the web site whether the user wants to access his own electronic safe deposit box or the electronic safe deposit box of another user as indicated in options 20 and 21. If the user elects to access another user's electronic safe deposit box, he will have to insert the other user's member log-in (also refereed to as other user's identification) in box 22. The user is required to insert his own PIN in box 23 and press the “Submit” key shown in box 24 to proceed further in the ESDB System. The information inserted on this page is encrypted using SSL technology when it is transmitted via the Internet In addition, all subsequent communications to and from the ESDB System are encrypted using SSL technology.

If the user's member log-in, password and PIN all correlate to the same user, the user is presented with a dynamic HTML page containing the folders of electronically stored files maintained by the ESDB System for that user as shown in FIG. 4. The ESDB System is personalized to greet the user as indicated in box 30. The user is presented with a menu of options under “Directory of Commands” set forth in menu 31. The user also has a menu of options under “Box Management Tools” in menu 32. If the user wants to perform some function with a written document stored on an electronic file contained in one of the listed folders in box 33, the user would click on the hypertext link folder containing the electronic file f such document

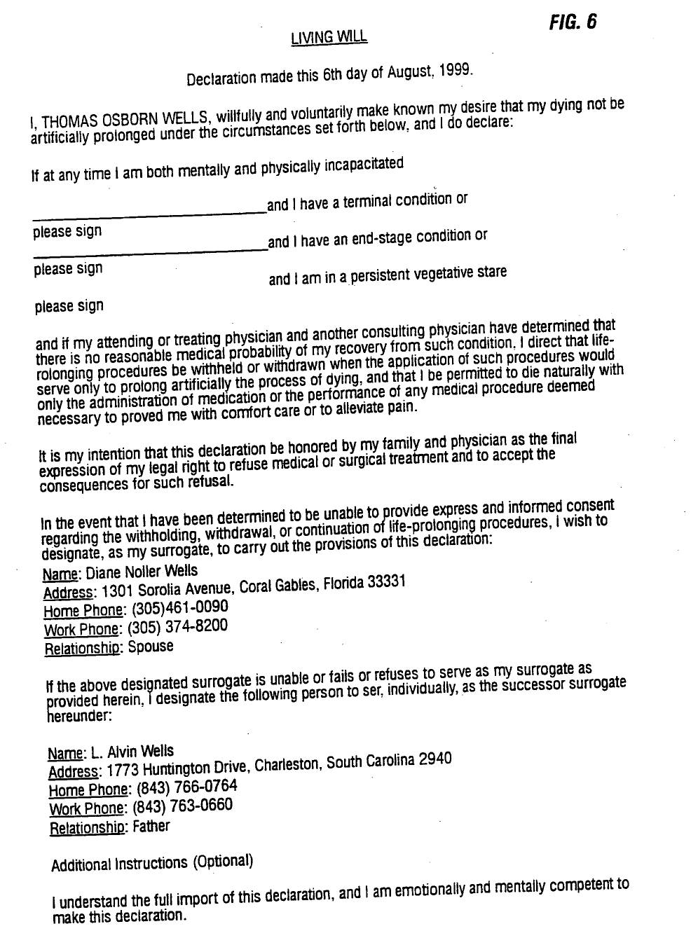

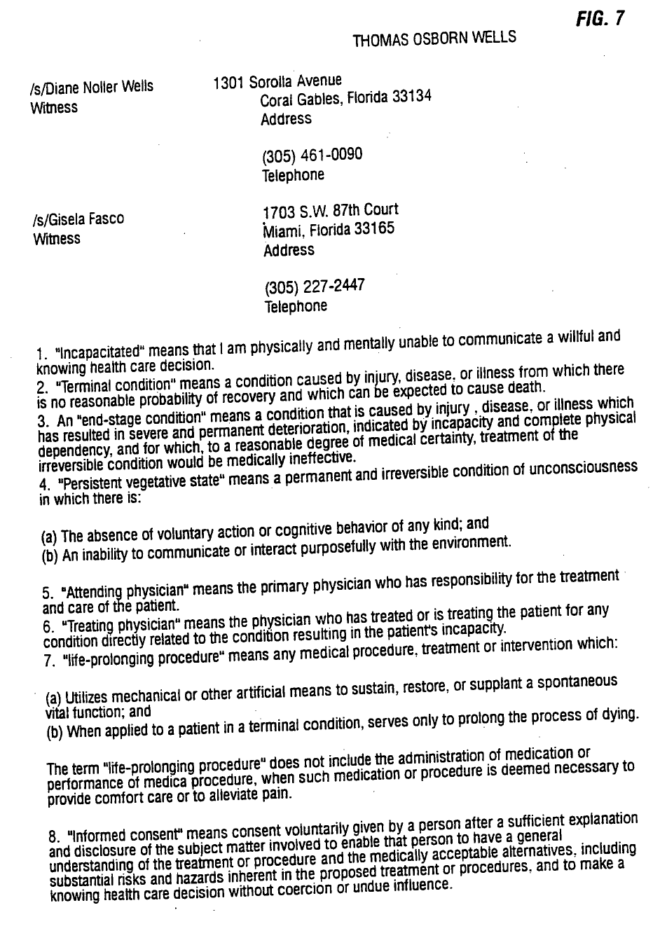

FIG. 5 assumes that the user has clicked the hypertext link “healthcare document folder” 40 in FIG. 4. The user is then presented with the title to the electronic files contained in that folder as shown in links 41, 42 and 43. If the user clicked the hypertext link “Living Will” in link 43, checked the “View Document” in box 44 and pressed the “Submit/Send” key in box 45, the user would be presented with the document shown in FIGS. 6 and 7. The user could use the browser “Back” function to return to the previous page shown in FIG. 5. The ESDB System will incorporate user navigation commands that do not currently appear at the top of the screen of the accessed document shown in FIGS. 6 and 7.

If the user elected to access the electronic safe deposit box of another user, he would check box 21 in FIG. 3 and add the member log-in/user identification for the owner of the other electronic safe deposit box in box 22. The user would add his own PIN in box 23 and check the “Submit” button shown at box 24.

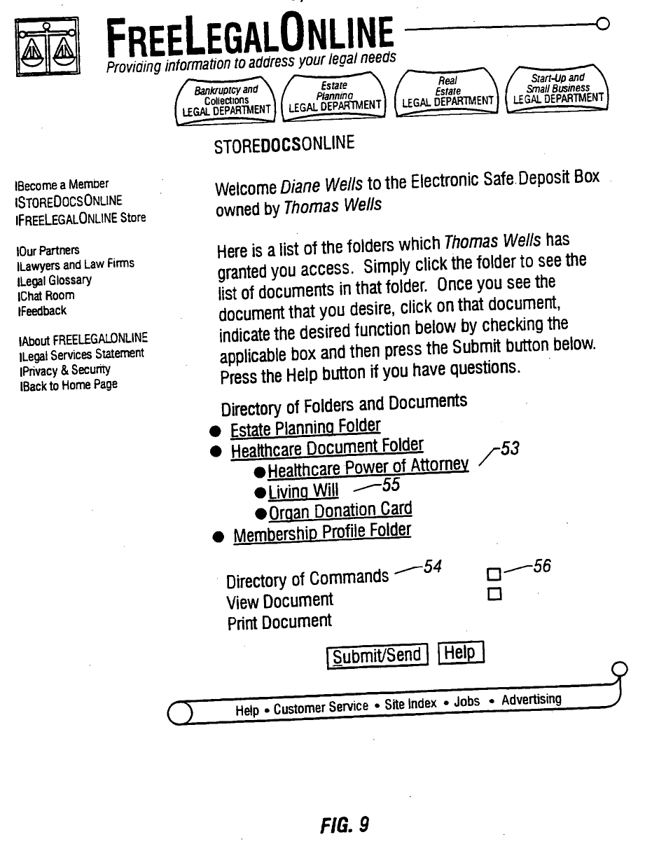

The user would then be presented with a dynamic HTML page as shown in FIG. 8. On this screen, the ESDB System greets the user and indicates that the user is accessing the electronic safe deposit box of someone else as shown in box 50. The user is presented with certain folders of electronic files as shown in box 51. The owner of the folders has previously granted the user access to these folders and electronic files stored in these folders. The user accesses a specific document by clicking the hypertext link folder coning the specific document For example, the user that clicks the hypertext link “Healthcare Document Folder” 52 would be presented with a dynamic HTML page shown in FIG. 9. The user can then select an individual document as shown in box 53 in FIG. 9 and view or print that document by checking the appropriate box in menu 54 in FIG. 9. If the user clicks the hypertext link “Living Will” in link 55 and checked the “View Document” in box 56, the ESDB System would present the user with the document shown in FIGS. 6 and 7.

When the owner is accessing his own electronic safe deposit box, he has access to certain “Box Management Tools” as shown in menu 32 in FIG. 4. This menu indicates those third parties who the user has given access to the user's box, the specific folders or files which such third parties can access, the aggregate size of user's electronic safe deposit box, the size of the files contained in such box, the unused storage space of such box and the date the license on such box expires. The “Box Management Tools” also allow the user to add/delete/modify third party access, increase the storage capacity of the box, renew the license to the box or review the box activity.

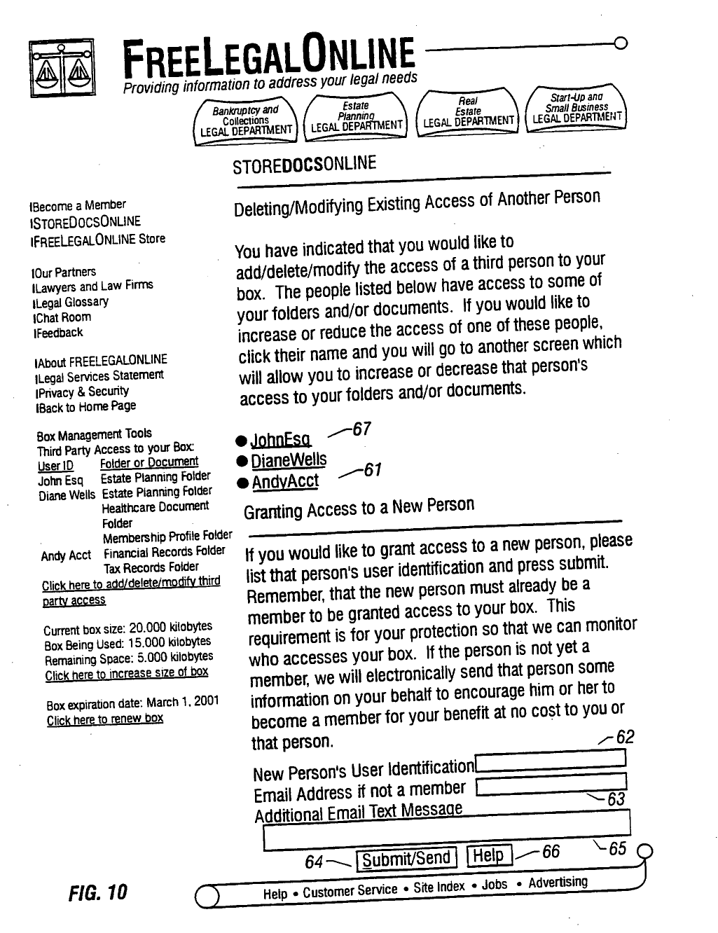

If the user requested to add/delete/modify third party access by clicking on the hypertext link 60 in FIG. 4, the ESDB System presents the user with a dynamic HTML page as shown in FIG. 10. This page shows the third parties who have access to certain folders or files in the user's electronic safe deposit box as shown in box 61. The user would click on to a hypertext link of a specific name in box 61 if he wanted to delete or modify the access of any such third party. The user also has the option of granting a new party access to certain folders or electronic files in his box by inserting the new third party's member log-in/user identification in box 62. If the requested third party is not a member, the user can send an automatic email to such third party resting that such party become a member of the ESDB System by inserting the email address of the third party in box 63 and pressing the “Submit/Send” key in box 64. The user also has an option of adding an additional personalized comment to the automatic email by inserting text into box 65 before pressing the “Submit/Send” key shown in box 64. The user can obtain assistance by pressing the “Help” key in box 66 that would then send the user to an electronic help desk with answers to frequently asked questions as well as the ability to send an email question to the administrator of the ESDB System.

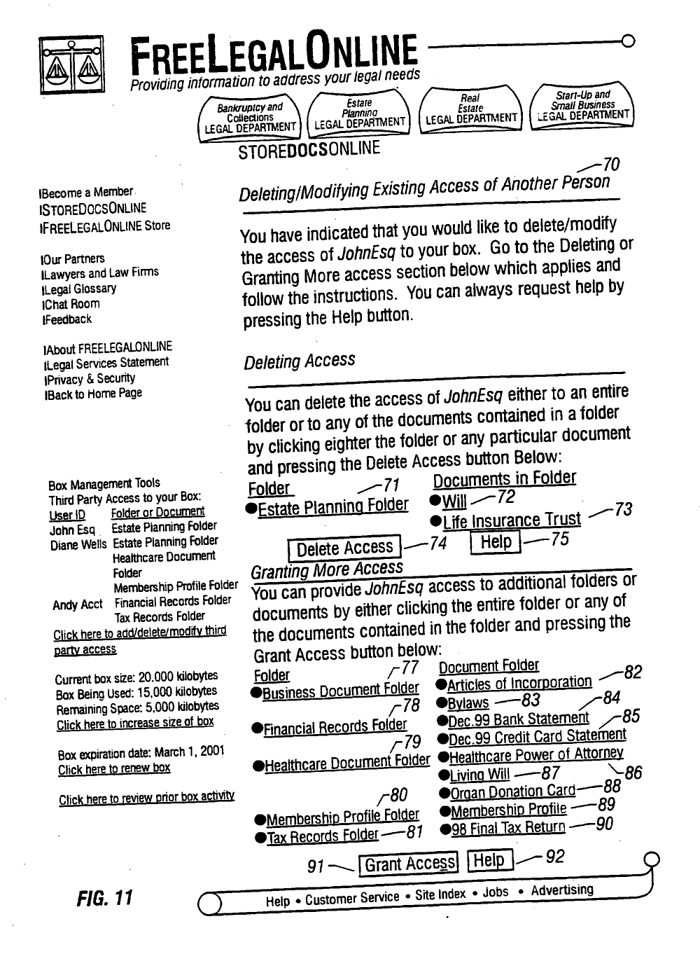

If the user clicked “JohnEsq” shown as a hypertext link 67 in FIG. 10 and pressed the “Submit/Send” key in box 64, the ESDB System presents the user with a dynamic HTML page shown in FIG. 11. This page allows the user to delete the access of “JobnEsq” to the folders and electronic files to which he currently has access by using the options in menu 70. Such access is deleted by clicking the hypertext link folder (which would delete the access of “JohnEsq” to all of the documents in that folder) as shown in hypertext link box 71 or by clicking the specific hypertext link electronic file shown in links 72 and 73 and then pressing the “Delete Access” key shown in box 74. The user can obtain assistance by pressing the “Help” key in box 75 that would then send the user to an electronic help desk with answers to frequently asked questions as well as the ability to send an email question to the administrator of the ESDB System.

The user can grant “JohnEsq” greater access to folders or specific electronic files contained in the user's electronic safe deposit box by selecting one of the hypertext links in box 76 shown in FIG. 11. Box 76 displays all of the folders and the electronic files in each folder to which “JohnEsq” does not currently have access. The user can grant “JohnEsq” access to all of the electronic files contained in a folder by clicking one or more hypertext link folders shown in links 77, 78, 79, 80, and 81 or access to a specific electronic file by clicking one or more of the hypertext link files shown in links 82, 83, 84, 85, 86, 87, 88, 89 and 90. After the user makes his selection, he presses the “Grant Access” key shown in box 91 which allows the ESDB System to record the requested action and grant “JohnEsq” access to the selected folder(s) or electric file(s). The user can obtain assistance by pressing the “Help” key in box 92 that would then send the user to an electronic help desk with answers to frequently asked questions as well as the ability to send an email question to the administrator of the ESDB System.

The ESDB System records the activity in a user's electronic safe deposit box and can display such activity by the user clicking the “Click here to review prior box activity” hypertext link 100 in FIG. 4. When such link is pressed, the user is shown a dynamic HTML page similar to FIG. 12. The information in box 101 indicates the prior activity for the user's electronic safe deposit box for the last 3 months as referenced in item 102. The ESDB System can display the activity in the user's box for any period of time (including periods exceeding 3 months) depending upon the programmable parameters of the ESDB System. The user can return to me previous page by pressing the “Back to Prior Screen” link 103.

While the invention has been described in the context of a preferred embodiment, it will be apparent to those skilled in the art that the present invention may be modified in numerous ways and may assume many embodiments other than that specifically set out and described above. Accordingly, it is intended by the appended claims to cover all modifications of the invention that fall within the true scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A computerized system for managing electronic data of a user over a network of computers comprising:
an electronic safe deposit box in electrical communication with said user, wherein said electronic safe deposit box stores a first user data file and a second user data file;
an alphanumeric designator which designates a first alphanumeric code to said fist data file and a second alphanumeric code to said second data file; and
an access controller to manage access to said electronic safe deposit box, said access controller interfacing via said network of computers with a third party having a unique designator.

2. The computerized system for managing electronic data of claim 1, wherein said user can designate a set of access privileges for said third party, said access privileges stored.

3. The computerized system for managing electronic data of claim 2, wherein said access privileges comprise read privileges.

4. The computerized system for managing electronic data of claim 3, wherein said access privileges comprise print privileges.

5. The computerized system for managing electronic data of claim 4, wherein said access privileges comprise modify privileges.

6. The computerized system for managing electronic data of claim 2, wherein said access controller prompts said third party to enter said unique designator, and determines whether said third party is authorized to access said electronic safe deposit box.

7. The computerized system for managing electronic data of claim 6, wherein said access controller prompts said third party to enter said first alphanumeric code to access said first data file.

8. The computerized system for managing electronic data of claim 7, wherein said access controller prompts said third party to enter said second alphanumeric code to access said second data file.

9. The computerized system for managing electronic data of claim 8, wherein said access controller monitors access to said electronic safe deposit box by said third party.

10. The computerized system for managing electronic data of claim 9, wherein said access controller automatically notifies said user when said third party commences access to said electronic safe deposit box.

11. The computerized system for managing electronic data of claim 9, wherein said access controller automatically notifies said user when said third party terminates access to said electronic safe deposit box.

12. The computerized system for managing electronic data of claim 9, wherein said access controller automatically notifies said user of a set of activities performed by said third party in relation to said first user data file.
